(19) United States
(12) Patent Application Publication
(10) Pub. No.: US 2004/0246956 A1
(43) Pub. Date: Dec. 9, 2004

(54) Parallel packet receiving, routing and forwarding

(76) Inventor: David Qiang Meng, Union City, CA (US)

Correspondence Address: BUCKLEY, MASCHOFF, TALWALKAR LLC, 5 ELM STREET, NEW CANAAN, CT, 06840, US

(21) Appl. No.: 10/456,893

(22) Filed: Jun. 6, 2003

(51) Int. Cl. H04L 12/56

(52) U.S. Cl. 370/389

(57) ABSTRACT

According to some embodiments, a first network packet and a second network packet are processed simultaneously. Packet processing may include reception of a plurality of m-packets of a network packet, performance of routing processing on a header of the network packet, and reassembly of the plurality of m-packets of the network packet in a memory.

### BACKGROUND

Conventional communication networks allow network devices to exchange messages with one another. A message may be transmitted in the form of multiple packets, each of which includes header information and a body. Network devices process the header information in order to route the multiple packets to their destination and to properly reassemble the message from the multiple packets.

Packets are therefore subjected to various processing as they travel through a network. The time required to process packets may limit the speed at which packets can be exchanged between network devices. As networks continue to physically support greater and greater data transmission speeds, efficient packet processing systems are increasingly desirable.

### BRIEF DESCRIPTION OF THE DRAWINGS

FIG. 1 is a block diagram of a network according to some embodiments.

FIG. 2 is a block diagram of a network processor according to some embodiments.

FIG. 3 is a block diagram of a network board according to some embodiments.

FIG. 4 is a functional block diagram illustrating conventional packet processing by a network processor.

FIG. 5 is a functional block diagram illustrating packet processing according to some embodiments.

FIGS. 6a through 6ecomprise a detailed flow diagram of a process according to some embodiments.

### DETAILED DESCRIPTION

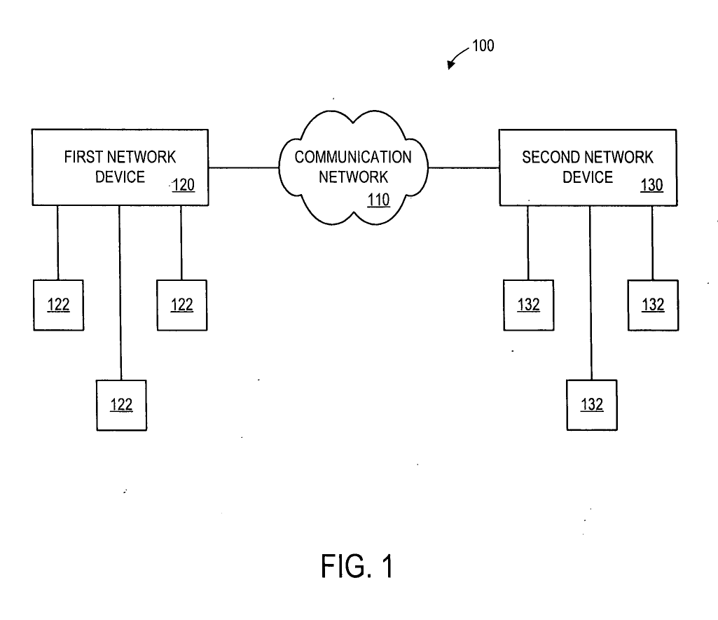

FIG. 1 is a block diagram of communication system 100. Communication system 100 includes communication network 110, which is in communication with first network device 120 and second network device 130. In particular, first network device 120 may exchange information with second network device 130 via communication network 110. Network devices 120 and 130 may comprise, for example, network switches or routers, such a device incorporating one or more IXP2400™ network processors available from Intel Corporation. A network switch or router may receive streams of data from other network devices such as personal computers and handheld devices, process the data, and forward the data to appropriate other network devices, including other network switches or routers. The data may be received and forwarded by several network devices until it reaches an appropriate destination.

Communication network 110 may comprise one or more network types, including but not limited to a Local Area Network (LAN), a Metropolitan Area Network (MAN), a Wide Area Network (WAN), a Fast Ethernet network, a wireless network, a fiber network, and/or an Internet Protocol (IP) network, such as the Internet, an intranet, or an extranet. Communication network 110 may support Layer 2 protocols, such as Ethernet Packet-Over SONET or ATM, in which data is transmitted in packet form. Moreover, communication network 110 may comprise one or more of any readable medium for transferring data, including coaxial cable, twisted-pair wires, fiber-optics, RF, infrared and the like. Communication network 110 may include any number of unshown network devices (e.g., intermediate switches and routers).

As illustrated in FIG. 1, first network device 120 may communicate with a number of associated network devices 122. Each of network devices 122 may comprise any device for communicating via network packets, including a personal computer, a personal digital assistant, a cellular telephone, or the like. Similarly, second network device 130 may communicate with a number of associated devices 132. One of devices 122 may thereby transmit a stream of network packets to one of devices 132. The network packets may be encapsulated and transmitted according to any network protocol according to some embodiments.

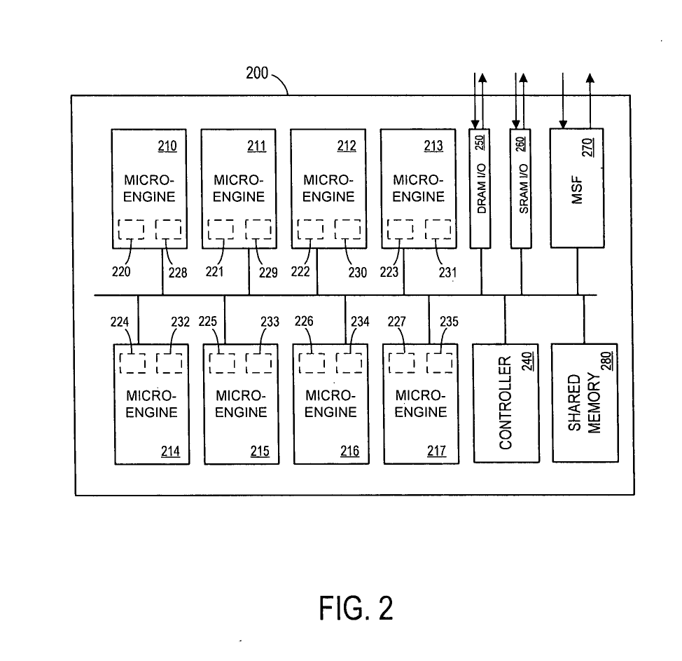

FIG. 2 is a block diagram of network processor 200 that may be used in conjunction with some embodiments. Network processor 200 may comprise the aforementioned IXP2400 network processor and may therefore be an element of network device 120. Other network processors, such as an IXP2800™ network processor, may be used in some embodiments.

Network processor 200 includes microengines 210 through 217, each of which is associated with a respective one of local memories 220 through 227. Each of microengines 210 through 217 may comprise a multi-threaded Reduced Instruction Set Computing (RISC) processor for processing network packets independently from one another. Each of microengines 210 through 217 supports eight threads of execution in the IXP2400 processor.

Microengines 210 through 217 also comprise a respective one of control stores 220 through 227. Stores 220 through 227 may store microcode including function calls that are executable by a respective microengine. A group of function calls used to perform particular packet processing is a microblock. The packet processing may include any type of processing, such as packet receiving, packet reassembly, and packet routing processing such as IPv6 forwarding, MPLS forwarding, and packet classification.

Each of microengines 210 through 217 contains a respective one of local memories 228 through 235. Local memories 228 through 235 each comprise memory storage for storing 640 long words (32 bits) of data. Local memories 228 through 235 are privately-addressable by their respective microengine and may be used by only the threads thereof for temporary storage during execution of a microblock. Local memories 228 through 235 may therefore be used to pass data between threads of a respective microengine. Each of microengines 210 through 217 may include additional storage, such as registers and content-addressable memories.

Network processor 200 also includes Controller 240. Controller 240 may comprise, for example, a control plane processor (e.g., an Intel® Xscale™ processor) that performs control and system management functions and executes real-time applications. DRAM I/O 250 receives and transmits information including network packets from and to a remote DRAM, and SRAM I/O 260 performs similar functions with respect to a remote SRAM.

Media and Switch Fabric (MSF) 270 couples processor 200 to a network physical (PHY) layer and/or a switch fabric. MSF 270 includes independent receive and transmit interfaces, as well as a receive buffer for storing incoming packets and a transmit buffer for storing outgoing packets. The receive buffer stores incoming packets in buffer sub-blocks known as elements. The receive buffer may store 8 KB of data, and the element size may be set to one of 64 B, 128 B or 256 B.

In operation, MSF 270 may break down a received network packet into multiple m-packets of the set element size, with each m-packet being stored as a data segment in an element of the receive buffer. A Receive Status Word (RSW) register of MSF 270 may include data bits that designate whether the m-packet represents a beginning, middle or end of the received network packet. These designations will be referred to herein as Start of Packet (SOP), Middle of Packet (MOP), and End of Packet (EOP). Some m-packets may be designated SOP/EOP because they represent an entire received network packet.

A thread may receive an indication from MSF 270 that the receive buffer has received a new m-packet. Threads of each microengine may read an element of the receive buffer. In this regard, each thread of a microengine may be associated with its own register set, program counter and thread-specific local registers within the microengine. Such an arrangement may allow a thread of a microengine to execute a computation while another thread of the microengine waits for an I/O procedure (e.g. external memory access) to complete or for a signal from another thread or hardware element.

Each thread may be in one of four states: inactive, executing, ready, or sleep. A thread is inactive if it is not to be used by a particular microblock executed by its microengine. An executing thread is in control of its microengine, and the program counter of an executing thread fetches program code to be executed. A thread remains in the executing state until it executes code that causes it to enter the sleep state.

In the ready state, a thread is ready to execute code but is not because another thread is in the executing state. When the executing thread enters the sleep state, a microengine arbiter selects a next thread to enter the executing state from all threads in the ready state. A thread in the sleep state is waiting for an external event to occur. This event may include completion of an I/O procedure and a signal from a hardware element or another thread.

According to some embodiments, only one thread of a microengine may be in the executing state at a given time. However, threads of different microengines may be in the executing state at the same time. Threads of different microengines may therefore process m-packets of a same or a different network packet simultaneously according to some embodiments. In some embodiments, each thread may execute identical microblocks to perform such processing, although different threads may execute the microblocks at different times.

Network processor 200 also includes shared memory 280 for quickly passing data between microengines and/or threads. Network processor 200 may include elements other than those illustrated in FIG. 2. For example, network processor 200 may include elements for communicating with a host processor over a standard PCI interface.

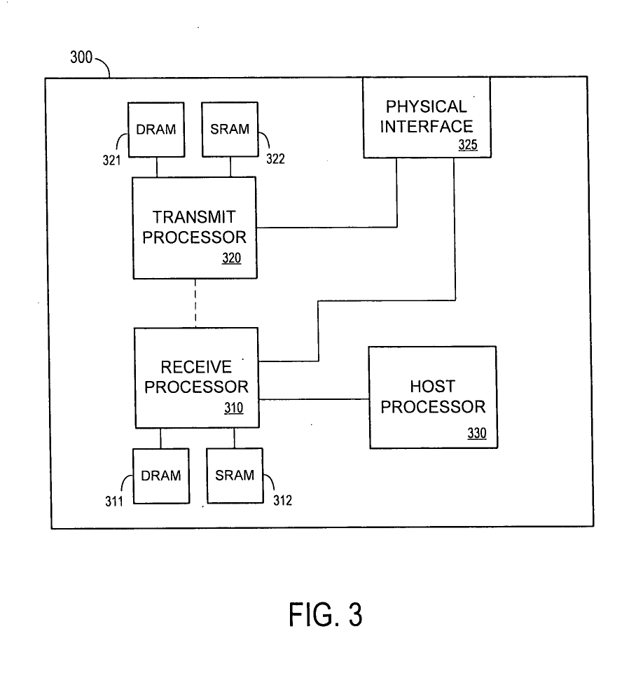

FIG. 3 is a block diagram of a network board according to some embodiments. Network board 300 may be an element of network device 120 of FIG. 1. Network board 300 includes transmit processor 310 and receive processor 320. One or both of transmit processor 310 and receive processor 320 may be implemented by network processor 200 of FIG. 2.

Receive processor 310 communicates with physical interface 325 via MSF 270 in order to receive network packets from a remote network device. Receive processor 310 may process the packets using DRAM 311 and SRAM 312. DRAM 311 and SRAM 312 may comprise any type of DRAM and SRAM, respectively, including Double Data Rate, Single Data Rate and Quad Data Rate memories. In some embodiments, m-packets representing the received network packets are stored in DRAM 311 during processing, while metadata associated with the packets is stored in SRAM 312. Similarly, transmit processor 320 may transmit network packets to a remote network device using physical interface 325, which is coupled to MSF 270 of processor 320. Prior to transmission, the packets may be processed using DRAM 321 and SRAM 322.

Host processor 330 is coupled to receive processor 310. Host processor 330 may control the general operation of network board 300.

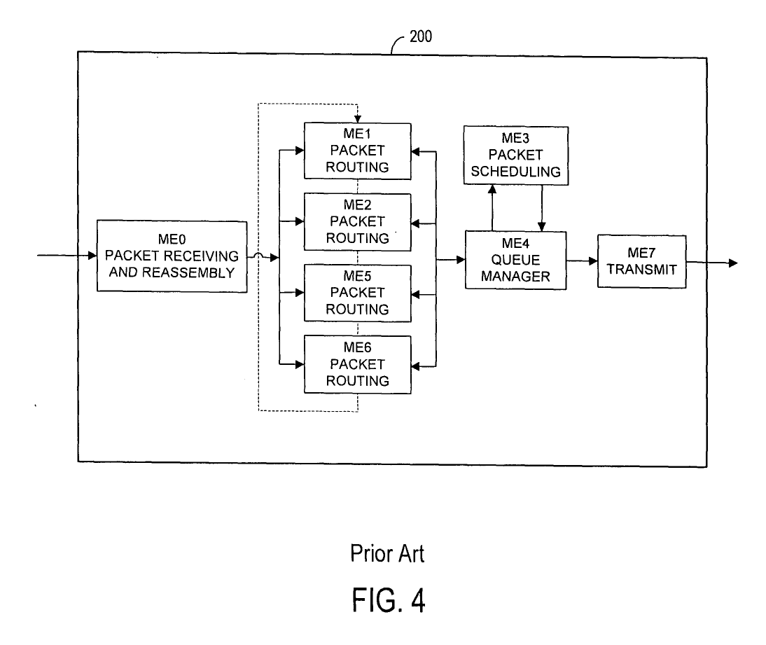

FIG. 4 is a functional block diagram illustrating conventional packet processing using network processor 200. As shown, threads of a first microengine (ME0) operate to receive m-packets and to reassemble the m-packets into a network packet. ME0 may store the reassembled network packet in DRAM 311.

ME1 then performs routing processing on the network packet. More specifically, thread 0 of ME1 reads the packet's header information from DRAM 311, performs routing processing on the packet, and stores updated header information back in DRAM 311. Thread 1 of ME1 performs routing processing on a next network packet after thread 0 has finished its routing processing. Threads 2 through 7 then perform routing processing on a next six network packets serially, and only after a previous thread has finished its routing processing. After thread 7 has finished its processing, an event signal is transmitted to ME2 instructing thread 0 of ME2 to perform routing processing on a next network packet.

Threads 0 through 7 of ME2 perform routing processing on a next eight network packets as described above with respect to ME1. Similar processing proceeds sequentially through ME5 and ME6, and then back to ME1. Therefore, routing processing conventionally proceeds in serial fashion, with no more than one thread of one microengine performing routing processing at any given time.

Routing processing may include one or more critical code segments. A thread executing a critical code segment may require exclusive access to a global resource such as a memory location. Accordingly, the above-described serial processing is intended to prevent other threads from accessing the resource while a thread executes the critical code segment.

To complete the description of FIG. 4, microengines ME3 and ME4 perform port loading of the network packets processed by ME1, ME2, ME5 and ME6. ME3 determines when a packet should be transmitted and ME4 determines a queue in which the network packet should be transmitted. ME4 may read header information of the network packet from DRAM 311 and determine the queue based on a port, a priority, and/or a next hub indicated in the header information. ME7 receives instructions from ME4 and, in response, stores a network packet from DRAM 311 in a transmit buffer of MSF 250 of processor 200.

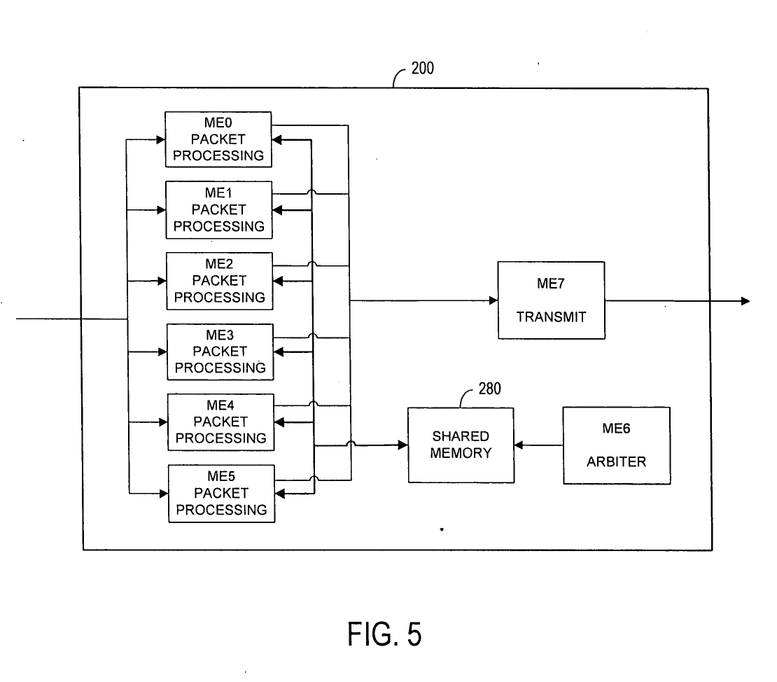

FIG. 5 is a functional block diagram of network processor 200 according to some embodiments. Generally, each thread of microengines ME0 through ME5 of FIG. 5 performs packet processing that includes the receipt of m-packets of a network packet, the performance of routing processing on a header of the first network packet, and the reassembly of the m-packets in a memory. Each thread of ME0 through ME5 may execute a same packet processing microblock to provide the described packet processing. In contrast to the FIG. 4 arrangement, packet processing of two network packets may occur simultaneously. According to one specific example, a thread of ME0 may reassemble m-packets of a first network packet while a thread of ME1 performs routing processing on a header of a second network packet.

Shared memory 280 may store information that is used by threads of different microengines during processing. For example, a thread of a first microengine may process a first m-packet of a network packet and a thread of a different microengine may process a second m-packet of the same network packet. Shared memory 280 may store a packet reassembly context that is associated with the network packet. The threads may use the packet reassembly context to determine where each m-packet of the network packet should be stored in DRAM 311.

ME6 provides arbiter functions for determining network packets to transmit to ME7. In this regard, threads of ME7 may execute a microblock for transmitting network packets to external devices. The arbiter and transmit functions may alternatively be provided by the packet processing microblock executed by the threads of ME0 through ME5.

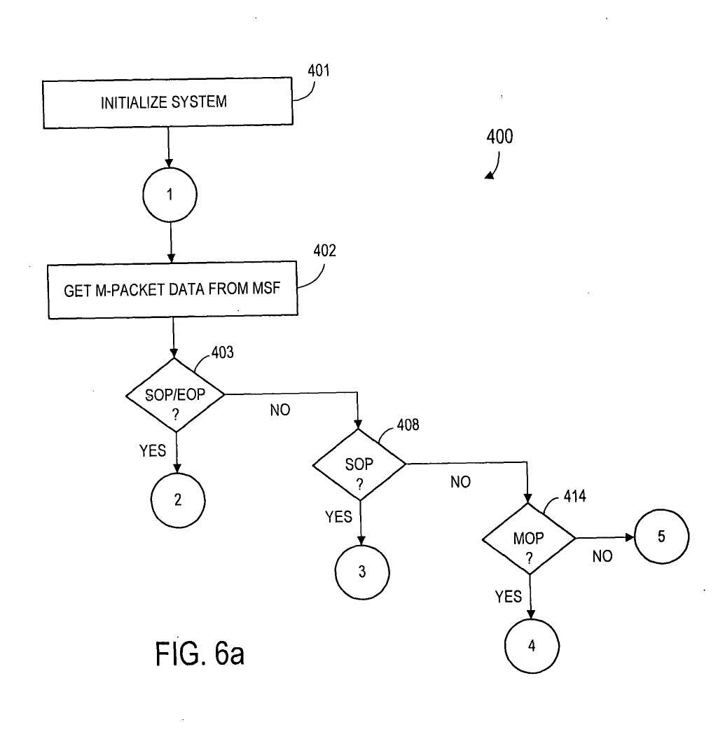

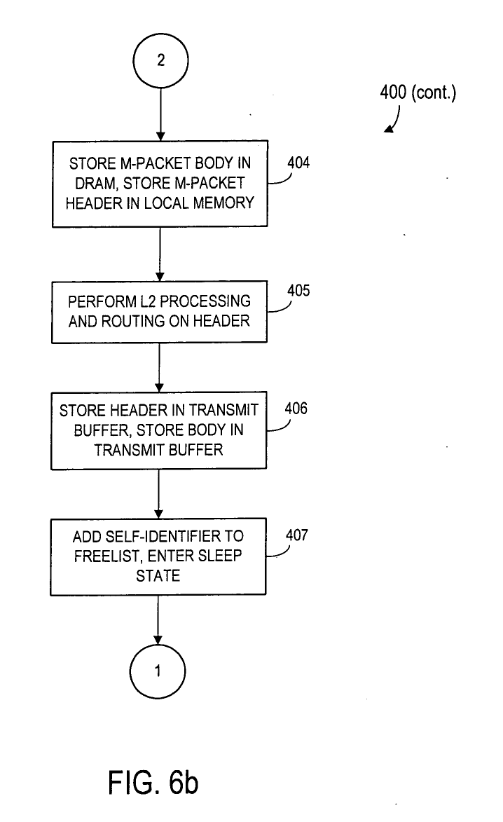

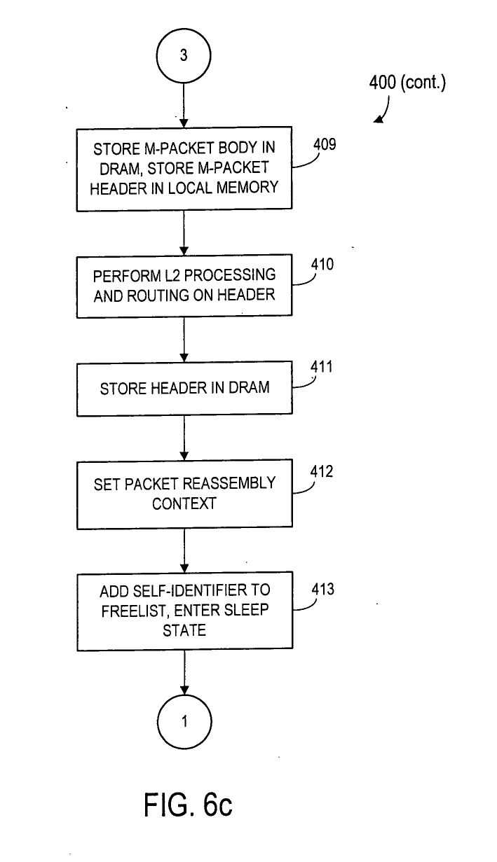

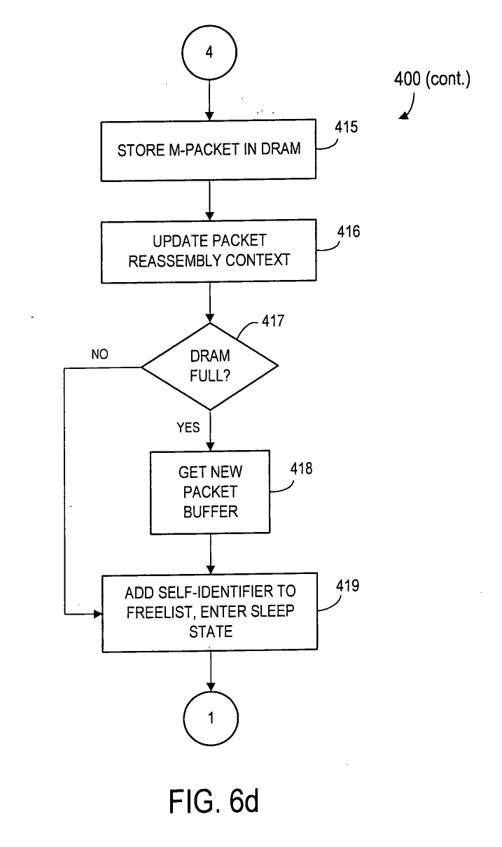

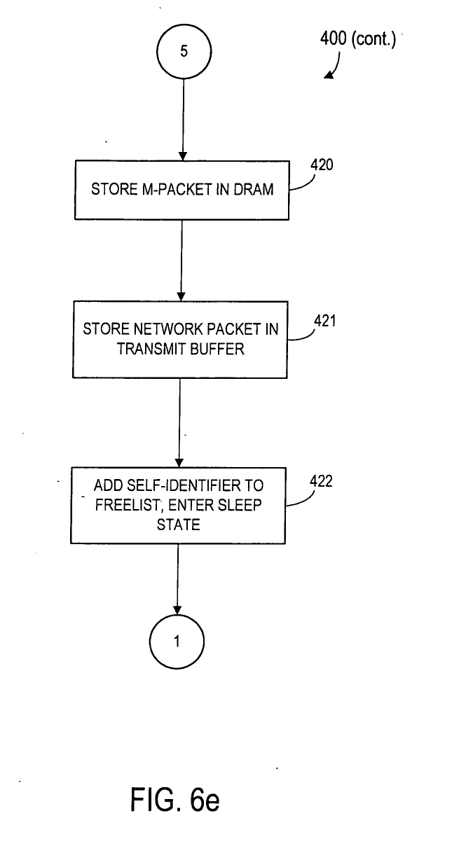

FIGS. 6a through 6h comprise a flow diagram of process 400 that may be executed by network device 120 after receipt of a network packet. Process 400 may be executed by each of a plurality of threads of one or more of microengines 210 through 217 of network processor 200. Process 400 may also be simultaneously executed by one thread of each of microengines 210 through 217 to provide real parallel packet processing.

Process 400 may be embodied in program code stored in one of control stores 220 through 227. The program code may be received by a control store from any medium, such as a hard disk, an IC-based memory, a signal, a network connection, or the like. In this regard, the program code may be included in a Software Developers' Kit associated with network processor 200.

The system is initialized at 401. In some embodiments, identifiers of all forty-eight threads of microengines 210 through 215 (corresponding to ME0 through ME5 of FIG. 5) are placed in a freelist that is associated with MSF 270. MSF 270 may send a signal to a first thread in the freelist when an m-packet is received, and may send a signal to a next thread in the freelist each time a next m-packet is received. As a result, the freelist determines the order in which the threads will process received m-packets.

The thread identifiers may be placed in the freelist in any order. For example, the first eight threads identified in the freelist may be threads 0 through 7 of microengine 210, the next eight threads may be threads 0 through 7 of microengine 211, and so on until threads 0 through 7 of microengine 212 comprise the last eight threads identified in the freelist. In another example, the first eight threads may comprise thread 0 of microengines 210 through 215, the next eight threads may comprise thread 1 of microengines 210 through 215, and so on until thread 7 of microengines 210 through 215 comprise the last eight identified threads of the freelist.

Initialization may also include allocating memory locations in DRAM 311 and SRAM 312 for storing, respectively, a network packet and a packet reassembly context that is associated with each input port supported by network processor 200. Four locations are allocated in each memory in a case that network processor 200 supports four ports. In this regard, network processor 200 may allow processing of one network packet of each port at a given time. In other words, hardware of network processor 200 may prevent interleaving of network packets that are associated with a same port. Memory locations of shared memory 280 that correspond to the allocated locations of SRAM 312 may also be allocated to provide the threads with fast access to packet reassembly contexts.

Next, at 402, a first thread in the freelist receives a signal from MSF 270 indicating that the receive buffer of MSF 270 has received an m-packet of a network packet. The thread then acquires data associated with the m-packet from a Receiving Status Word (RSW) register of MSF 270. The RSW register may include one or more of a byte count, a port number, a packet type (SOP, MOP, EOP, SOP/EOP), and other information.

Based on the acquired data, it is determined if the m-packet is an SOP/EOP packet at 403. If so, a body of the m-packet is stored in DRAM 311 from the receive buffer and a header of the m-packet is stored in a local memory from the receive buffer at 404. The storage locations correspond to the locations allocated at 401 for the input port of the m-packet. The local memory may comprise any memory that is accessible by the currently-executing thread, such as a respective one of local memories 228 through 235, shared memory 280, or SRAM 312. In some embodiments, the body of the m-packet is moved directly from the receive buffer to the transmit buffer of MSF 270 at 404.

The thread performs Layer 2 processing (e.g. Ethernet classification, MAC filtering) and other packet processing including routing processing on the stored header at 405. The other processing may include MPLS, push/pop or other processing. The routing processing may comprise any routing processing, including applying a Longest Prefix Match Algorithm to the header, and determining a nexthop based on a routing table and on a destination address prefix and mask. Queue management and scheduling functions may also be performed at 405. The determined nexthop, queue, and scheduling information may be stored at the allocated location of SRAM 312 that corresponds to the output port of the m-packet.

The header and the body are stored in the transmit buffer of MSF 270 at 406. Accordingly, MSF 270 then transmits the m-packet (which is a complete network packet) according to the stored nexthop, queue, and scheduling information. The executing thread adds an identifier of itself to the end of the freelist in 407 and enters the sleep state. The executing thread will wake and begin executing process 400 at 402 after each other thread in the freelist has processed an m-packet received by MSF 270.

If it is determined at 403 that the m-packet is not an SOP/EOP packet, the thread determines if the m-packet is an SOP packet at 408. If so, a body of the m-packet is stored in DRAM 311 and a header of the m-packet is stored in a local memory at 409 in the memory locations corresponding to the input port of the m-packet. The storage location of the body may be offset from the beginning of the allocated location by an expected header length. The thread then performs Layer 2 processing and other packet processing including routing processing on the stored header at 410. Again, queue management and scheduling functions may also be performed at 410. The determined nexthop, queue, and scheduling information may also be stored at an allocated location of SRAM 312 that corresponds to the output port of the m-packet.

At 411, the header is stored in DRAM 311 at the memory location that corresponds to the input port of the m-packet. The stored header may differ from the header stored at 409 due to the processing at 410. A packet reassembly context is set and stored in the allocated location of SRAM 312 at 412. The packet reassembly context may include a packet buffer handle that specifies a location in which a next m-packet will be stored in DRAM 311, as well as a packet sequence number, a packet size, a buffer size, and a packet reassembly state. The context may be stored in shared memory 280 or in any other memory shared among microengines 210 through 217. The packet reassembly context may be cached in one of local memories 228 through 235 and accessed using a content-addressable memory using known techniques.

The executing thread then adds an identifier of itself to the end of the freelist at 413 and enters the sleep state. As described above, the executing thread will wake and begin executing process 400 at 402 after each other thread in the freelist has processed an m-packet received by MSF 270.

If it is determined at 408 that the m-packet is not an SOP packet, the thread determines if the m-packet is an MOP packet at 414. If so, the entire m-packet, which comprises all or a portion of the body of its associated network packet, is stored in DRAM 311 at 415. The storage location is determined based on an input port of the m-packet, which may itself be determined based on the RSW register associated with the m-packet. Since all threads may determine memory storage locations associated with each input port, threads of various microengines may receive and reassemble m-packets of a single network packet.

The packet reassembly context associated with the current input port is updated at 416. Specifically, a packet buffer handle and a packet size indicated in the context are updated based on the size of the received m-packet. Next, at 417, the thread determines if another m-packet can be stored in the memory locations of DRAM 311 that were allocated for the current port. If so, it is determined that the current packet buffer of DRAM 311 is full and a new packet buffer of DRAM 311 is acquired for the current input port at 418. Also at 418, the packet buffer handle of the packet reassembly context is updated to reflect the location of the new packet buffer.

The executing thread adds an identifier of itself to the end of the freelist and enters the sleep state at 419. The executing thread will then wake and begin executing process 400 at 402 after each other thread in the freelist has processed an m-packet received by MSF 270. Flow proceeds directly from 417 to 419 in a case that the thread determines that the current packet buffer of DRAM 311 is not full at 417.

Returning to 414, the m-packet is an EOP packet if the determination in 414 is negative. Accordingly, the m-packet is stored in DRAM 311 at a location based on the packet buffer handle of the packet reassembly context at 420. The entire network packet that is now located in DRAM 311 is then stored in the transmit buffer of MSF 270 at 421. Next, at 422, the thread adds a self-identifier to the end of the freelist and enters the sleep state. The thread wakes at 402 upon receipt of a signal from MSF 270.

Some embodiments use semaphores to control access to the above-described packet reassembly contexts. For example, a semaphore may be associated with each input port. The semaphore associated with a port is a flag that may indicate whether the resources associated with the input port may be freely accessed. Any thread that desires to update a memory location and/or data (e.g. header information, packet reassembly context) associated with an input port must first examine the semaphore associated with the input port to determine if the resources may be accessed. If not, the thread waits until the semaphore indicates that the resources may be freely accessed, updates the semaphore to indicate to other threads that the resources may not be freely accessed, accesses the necessary resources, and updates the semaphore to indicate to the other threads that the resources may be freely accessed. Such an arrangement ensures that only one thread may alter information associated with an input port at any one time. However, since each input port is associated with its own semaphore, two threads may simultaneously perform packet processing on m-packets of two different input ports.

The several embodiments described herein are solely for the purpose of illustration. Embodiments may include any currently or hereafter-known versions of the elements described herein. Therefore, persons in the art will recognize from this description that other embodiments may be practiced with various modifications and alterations.

What is claimed is:

1. A method comprising:
processing a first network packet, wherein processing the first network packet comprises:
receiving a plurality of m-packets of a first network packet;
performing routing processing on a header of the first network packet; and
reassembling the plurality of m-packets of the first network packet in a memory; and
processing a second network packet, wherein processing the second network packet comprises:
receiving a plurality of m-packets of a second network packet;
performing routing processing on a header of the second network packet; and
reassembling the plurality of m-packets of the second network packet in the memory,
wherein the first network packet and the second network packet are processed simultaneously.

2. A method according to claim 1, wherein the first network packet is processed by a first microengine and the second network packet is processed by a second microengine.

3. A method according to claim 2,
wherein the first network packet is processed by a plurality of threads of the first microengine and the second network packet is processed by a plurality of threads of the second microengine.

4. A method according to claim 1, wherein receiving the plurality of m-packets of the first network packet comprises:
receiving a first m-packet of the first network packet, the first m-packet including the header of the first network packet;
storing a body of the first m-packet in the memory; and
storing the header in a local memory, wherein the header is not stored in the memory between receiving the first m-packet and performing routing processing on the header.

5. A method according to claim 4, further comprising:
storing the header in a transmit buffer; and
storing the body in the transmit buffer.

6. A method according to claim 4, wherein reassembling the plurality of m-packets of the first network packet in the memory comprises:
storing the header in the memory; and
storing a context of the first network packet in a shared memory.

7. A method according to claim 6, wherein the memory is shared among a plurality of microengines, and wherein the context comprises a pointer to the first network packet and a size of the first network packet.

8. A medium storing program code, the program code executable to:
process a first network packet, wherein processing of the first network packet comprises:
receiving of a plurality of m-packets of a first network packet;
performance of routing processing on a header of the first network packet; and
reassembling the plurality of m-packets of the first network packet in a memory; and
process a second network packet, wherein processing the second network packet comprises:
receiving a plurality of m-packets of a second network packet;
performing routing processing on a header of the second network packet; and
reassembling the plurality of m-packets of the second network packet in the memory,
wherein the first network packet and the second network packet are to be processed simultaneously.

9. A medium according to claim 8, wherein the first network packet is to be processed by a first microengine and the second network packet is to be processed by a second microengine.

10. A medium according to claim 9,
wherein the first network packet is processed by a plurality of threads of the first microengine and the second network packet is processed by a plurality of threads of the second microengine.

11. A medium according to claim 8, wherein receiving the plurality of m-packets of the first network packet comprises:
receiving a first m-packet of the first network packet, the first m-packet including the header of the first network packet;
storing a body of the first m-packet in the memory; and
storing the header in a local memory,
wherein the header is not stored in the memory between receiving the first m-packet and performing routing processing on the header.

12. A medium according to claim 11, the program code further executable to:
store the header in a transmit buffer; and
store the body in the transmit buffer.

13. A medium according to claim 11, wherein reassembling the plurality of m-packets of the first network packet in the memory comprises:
storing the header in the memory; and
storing a context of the first network packet in a shared memory.

14. A medium according to claim 13, wherein the memory is shared among a plurality of microengines, and wherein the context comprises a pointer to the first network packet and a size of the first network packet.

15. A method for each of a plurality of execution threads to process network packets, the method comprising:
receiving an m-packet of a first network packet;
if the m-packet is a start packet, storing a body of the m-packet in a packet buffer of a memory, storing a header of the m-packet in a local memory, performing routing processing on the header, storing the header to the packet buffer, storing a packet reassembly context in a shared memory shared by the plurality of execution threads, the packet reassembly context including a pointer to the first network packet in the memory and a size of the first network packet, adding a self-identifier to a freelist, and entering a sleep state;
if the m-packet is a middle packet, storing the m-packet in the packet buffer at a location based on the packet reassembly context, updating the packet reassembly context based on the stored m-packet, adding the self-identifier to the freelist, and entering the sleep state; and
if the m-packet is an end packet, storing the m-packet in the packet buffer at the location based on the packet reassembly context, transmitting the network packet, adding the self-identifier to the freelist, and entering the sleep state.

16. A method according to claim 15, further comprising:
if the m-packet is a middle packet or if the m-packet is an end packet, determining an input port associated with the first network packet, and determining a location of the packet reassembly context based on the determined input port.

17. A method according to claim 16, further comprising:
if the m-packet is a middle packet, determining if the packet buffer is full after storing the m-packet in the packet buffer, receiving a new buffer if the packet buffer is full, and updating the packet reassembly context based on the new buffer.

18. A medium storing program code, the program code executable to:
receive an m-packet of a first network packet;
if the m-packet is a start packet, store a body of the m-packet in a packet buffer of a memory, store a header of the m-packet in a local memory, perform routing processing on the header, store the header in the packet buffer, store a packet reassembly context in a shared memory to be shared by a plurality of execution threads, the packet reassembly context to include a pointer to the first network packet in the packet buffer and a size of the first network packet, add a self-identifier to a freelist, and enter a sleep state;
if the m-packet is a middle packet, store the m-packet in the packet buffer at a location based on the packet reassembly context, update the packet reassembly context based on the stored m-packet, add the self-identifier to the freelist, and enter the sleep state; and
if the m-packet is an end packet, store the m-packet in the packet buffer at the location based on the packet reassembly context, transmit the network packet, add the self-identifier to the freelist, and enter the sleep state.

19. A medium storing program code according to claim 18, the program code further executable to:
if the m-packet is a middle packet or if the m-packet is an end packet, determine an input port associated with the first network packet, and determine a location of the packet reassembly context based on the determined input port.

20. A medium storing program code according to claim 18, the program code further executable to:
if the m-packet is a middle packet, determine if the packet buffer is full after storing the m-packet in the packet buffer, receive a new buffer if the packet buffer is full, and update the packet reassembly context based on the new buffer.

21. A device comprising:
a processor; and
a control store associated with the processor, the control store storing program code executable by the processor to invoke a plurality of threads of execution, each of the threads of execution to:
receive an m-packet of a first network packet;
if the m-packet is a start packet, store a body of the m-packet in a packet buffer of a memory, store a header of the m-packet in a local memory, and perform routing processing on the header;
if the m-packet is a middle packet, store the m-packet in the packet buffer; and
if the m-packet is an end packet, store the m-packet in the packet buffer, and transmit the network packet.

22. A device according to claim 21, each of the threads of execution further to:
if the m-packet is a middle packet or if the m-packet is an end packet, determine an input port associated with the first network packet, and determine a location of a packet reassembly context based on the determined input port.

23. A device according to claim 21, each of the threads of execution further to:
if the m-packet is a middle packet, determine if the packet buffer is full after storing the m-packet in the packet buffer, receive a new buffer if the packet buffer is full, and update a packet reassembly context based on the new buffer.

24. A device according to claim 21, each of the threads of execution further to:
if the m-packet is a start packet, store the header in the packet buffer, store a packet reassembly context in a shared memory to be shared by a plurality of execution threads, the packet reassembly context to include a pointer to the first network packet in the packet buffer and a size of the first network packet, add a self-identifier to a freelist, and enter a sleep state.

25. A device according to claim 21, each of the threads of execution further to:
if the m-packet is a middle packet, store the m-packet in the packet buffer at a location based on the packet reassembly context, update the packet reassembly context based on the stored m-packet, add the self-identifier to a freelist, and enter a sleep state.

26. A system comprising:
a processor;
a Double Data Rate random access memory coupled to the processor; and
a control store associated with the processor, the control store storing program code executable by the processor to invoke a plurality of threads of execution, each of the threads of execution to:
receive an m-packet of a first network packet;
if the m-packet is a start packet, store a body of the m-packet in a packet buffer of the Double Data Rate random access memory, store a header of the m-packet in a local memory, and perform routing processing on the header;
if the m-packet is a middle packet, store the m-packet in the packet buffer; and
if the m-packet is an end packet, store the m-packet in the packet buffer, and transmit the network packet.

27. A system according to claim 26, each of the threads of execution further to:
if the m-packet is a middle packet or if the m-packet is an end packet, determine an input port associated with the first network packet, and determine a location of a packet reassembly context based on the determined input port.

28. A system according to claim 26, each of the threads of execution further to:
if the m-packet is a middle packet, determine if the packet buffer is full after storing the m-packet in the packet buffer, receive a new buffer if the packet buffer is full, and update a packet reassembly context based on the new buffer.

29. A device according to claim 26, each of the threads of execution further to:
if the m-packet is a start packet, store the header in the packet buffer, store a packet reassembly context in a shared memory to be shared by a plurality of execution threads, the packet reassembly context to include a pointer to the first network packet in the packet buffer and a size of the first network packet, add a self-identifier to a freelist, and enter a sleep state.

30. A device according to claim 26, each of the threads of execution further to:
if the m-packet is a middle packet, store the m-packet in the packet buffer at a location based on the packet reassembly context, update the packet reassembly context based on the stored m-packet, add the self-identifier to a freelist, and enter a sleep state.
